(19) United States
(12) Patent Application Publication
(10) Pub. No.: US 2022/0061315 A1
(43) Pub. Date: Mar. 3, 2022

(54) PERSISTENT SANITIZER

(71) Applicant: Simply Pure, LLC, Palo Alto, CA (US)

(72) Inventors: Douglas Wescott Thomas, Palo Alto, CA (US); Reem Mahrat, Palo Alto, CA (US)

(21) Appl. No.: 17/458,524

(22) Filed: Aug. 26, 2021

Related U.S. Application Data
(60) Provisional application No. 63/070,821, filed on Aug. 26, 2020.

(51) Int. Cl. A01N 25/04; A01N 33/12; A01N 59/16; A01N 57/12

(52) U.S. Cl. CPC A01N 25/04; A01N 57/12; A01N 59/16; A01N 33/12

(57) ABSTRACT

Provided herein are compositions and related methods related to a class of formulation that can be applied once a day and still provide antimicrobial and/or antiviral protection during this period, thus exhibiting persistent sanitization to the user. In some embodiments, a hand cream with antimicrobial and/or antiviral protection can prevent against COVID-19 spread or infection. In some embodiments, the formulation comprises one or more of the following: benzalkonium chloride, zinc oxide, tributyl phosphate, soybean oil, and/or Triton X-100, or an analog, derivative, salt, or pharmaceutical equivalent thereof, with the formulation containing a predominance of water to prevent a greasy feel to the user.

### CROSS-REFERENCES TO RELATED APPLICATIONS

This application claims the benefit of U.S. Provisional Application No. 63/070,821, filed Aug. 26, 2020, and entitled “PERSISTENT SANITIZER,” which is herein incorporated herein by reference in its entirety for all purposes.

### FIELD OF THE INVENTION

The present disclosure relates to the field of pharmaceuticals and is more specifically related to sanitization.

### BACKGROUND

The following description in this section of the present application may include information that may be useful in understanding the present invention. It is not an admission that any of the information provided herein is prior art or relevant to the presently claimed invention, or that any publication specifically or implicitly referenced is prior art.

There is currently a great interest and need in the public for sanitizers that contain antibacterial and antiviral properties. For example, the recent international pandemic caused by the coronavirus COVID-19 has increased the public awareness and desire for effective formulations and compositions that can be used to sanitize commonly used surfaces as well as to sanitize hands, such as a leave-on sanitizing hand cream, for example, to help prevent the spread and further infection by the disease. Commercially available hand sanitizers provide a point of protection where once one has come in contact with a contaminated surface or object, or has come in contact with another person, they can be used to flash sanitize the hands to kill microbes and inactivate viruses. However, this protection does not persist, and one must typically apply it each time one comes in contact with such sources. Thus, there is a need in the art for more effective sanitization compounds and compositions.

### BRIEF SUMMARY

In some embodiments, a persistent sanitizer composition comprises a formulation base of one or more bioactive compounds that remains active throughout an entire day after application, wherein the formulation base comprises a composition of one or more of the following components: benzalkonium chloride; zinc oxide nanoparticles; tributyl phosphate; soybean oil or non-allergenic fatty acid; and Triton X-100, or an analog, derivative, salt, or pharmaceutical equivalent thereof, and wherein the composition is a hand cream with antibacterial and/or antiviral properties.

In further embodiments, a sanitizer composition comprises one or more antimicrobial and/or antiviral components and a water and oil formulation, wherein the water and oil formulation contains a predominance of water. The composition may comprise benzalkonium chloride, zinc source, tributyl phosphate, soybean oil, and/or Triton X-100, or an analog, derivative, salt, or pharmaceutical equivalent thereof. The benzalkonium chloride can comprise a concentration of 0.1-0.2% and preferably a concentration of 0.18%. The zinc source can comprise a concentration of 0.01-0.1%. In some aspects, the zinc source is zinc oxide nanoparticles with a concentration of 0.075%. In some aspects, the zinc source includes zinc salts and their hydrates with a concentration of 0.05-4%. In some aspects, the tributyl phosphate comprises a concentration range of 0.08-0.8%. In some cases, the soybean oil or non-allergenic fatty acid comprises a concentration range of 0.64-6.4%. In some embodiments, the Triton X-100 comprises a concentration range of 0.08-0.8%. In some embodiments, a nanoemulsion of the zinc source is formed using: tributyl phosphate or an analog; soybean oil or an analog; and Triton X-100. In some aspects, the nanoemulsion comprises 1-10% of the sanitizer composition. The composition can be a cream (e.g., a hand cream). The sanitizer composition (e.g., the water and oil formulation) may have no ethyl and/or isopropyl alcohol. In some cases, the predominance of water provides a non-greasy feel to the user. The sanitizer composition can comprise a formulation base of bioactive compounds that will continue to remain active throughout the day after application by a user. The composition typically reduces, prevents and/or treats conditions associated with infection by viruses, including but not limited to, COVID-19.

In further embodiments, a method of sanitizing a surface or user comprises: providing a composition comprising one or more antimicrobial and/or antiviral components and a water and oil formulation, wherein the water and oil formulation contains a predominance of water; and administering an effective amount of the composition to the surface or user, wherein the composition includes one or more of the following: benzalkonium chloride; zinc oxide nanoparticles; tributyl phosphate; soybean oil; and/or Triton X-100 or an analog, derivative, salt, or pharmaceutical equivalent thereof, wherein the composition reduces, prevents and/or treat conditions associated with infection by viruses, including COVID-19. In some cases, the composition is administered topically to the user as a hand cream.

### BRIEF DESCRIPTION OF THE DRAWINGS

FIG. 1 shows a process diagram for the production of a persistent sanitizing compound, according to certain embodiments; and

FIG. 2 shows a method of sanitizing a surface or user, according to certain embodiments.

### DETAILED DESCRIPTION

All references, publications, and patents cited in this section are incorporated by reference in their entirety as though they are fully set forth. Unless defined otherwise, technical and scientific terms used herein have the same meaning as commonly understood by one of ordinary skill in the art to which this invention belongs. Hornyak, et al., Introduction to Nanoscience and Nanotechnology, CRC Press (2008); Singleton et al., Dictionary of Microbiology and Molecular Biology 3rd ed., J. Wiley & Sons (New York, N.Y. 2001); March, Advanced Organic Chemistry Reactions, Mechanisms and Structure 7th ed., J. Wiley & Sons (New York, N.Y. 2013); and Sambrook and Russel, Molecular Cloning: A Laboratory Manual 4th ed., Cold Spring Harbor Laboratory Press (Cold Spring Harbor, N.Y. 2012), provide one skilled in the art with a general guide to many of the terms used in the present application.

As used herein, the term “Persistent Sanitizer” may refer to a class of formulation containing predominance of water in a water and oil formulation as to impart a non-greasy feel to the user. This class of formulation can be applied once a day by the user (or more), and provides antimicrobial and/or anti-viral protection during this period and thus exhibit persistence.

As used herein, the term “anti-viral” or “antiviral” m a y refer to the ability to inactivate enveloped viruses, as well as non-enveloped viruses.

As used herein, the term “topical application” may refer to being applied to a surface such as skin.

As used herein, the term “topically active” may refer to the composition or medicament for topical application which treats predominately the surface on which it is applied.

As described herein, in accordance with various embodiments herein, aspects of the invention relate to a class of hand creams that contain several components at concentrations shown to possess antimicrobial activity through separate mechanisms of action. Also described herein are additional compounds showing the ability at the described concentrations to have antiviral (ability to inactivate enveloped viruses) activity. The described formulations of these compounds are water/oil formulations containing a predominance of water as to impart a non-greasy feel. This class of formulation is designed to be applied once a day (or more), provide antimicrobial and antiviral protection during this period, and thus exhibit persistence. This class of formulation is referred to as “Persistent Sanitizer”.

Certain embodiments can include a composition comprising one or more antimicrobial and/or antiviral components, and a water and oil formulation, wherein the water and oil formulation contains a predominance of water. In some embodiments, the composition provides a non-greasy feel to the user. In some embodiments, the composition can be a cream. In further embodiments, the composition can be a hand cream. In some implementations, the composition can be used for topical administration to a user. In some embodiments, the composition is for administration to a user once a day. In certain embodiments, the composition can be administered to a user once a day (or more) and provides antimicrobial and/or antiviral protection to the user during this period.

Various components and concentrations of components can be included in conjunction with the various embodiments of compositions herein, including antimicrobial, antiviral, oil, and bio-active components and their relative concentrations in formulation. In some embodiments, the invention described herein provides a composition comprising benzalkonium chloride, zinc source (e.g., zinc salts and their hydrates such as zinc sulfate, zinc chloride, zinc gluconate, zinc oxide and its forms (e.g., nanoemulsions and nanoparticles)), tributyl phosphate, soybean oil, and/or Triton X-100, or an analog, derivative, salt, or pharmaceutical equivalent thereof. In some embodiments, the benzalkonium chloride comprises a concentration of 0.1-0.2%. In certain embodiments, the benzalkonium chloride comprises a concentration of 0.12%. In certain embodiments, the zinc oxide comprises a concentration of 0.05-0.1%. In some embodiments, the zinc source (e.g., nanoemulsion) comprises a concentration of 0.075%. In certain embodiments, the tributyl phosphate comprises tributyl phosphate (8 parts) at a range of 0.08-0.8%. In certain embodiments, the soybean oil comprises soybean oil (64 parts) at a range of 0.64-6.4%. In some embodiments, the Triton X-100 comprises Triton X-100 (8 parts) at a range of 0.08-0.8%. In certain embodiments, the bioactive compounds of the formulation contributes less than 9% of the total formulation weight for weight, with the remaining portion of the formulation comprising constituents commonly found in hand creams. In certain embodiments, water provides greater than 50% of the formulation. In some embodiments, the formulation has no ethyl and/or isopropyl alcohol.

As described herein, while currently in the art there are hand sanitizers that provide a point of protection, this protection does not persist though as the user typically has to apply it each time one comes in contact with such sources. In contrast, various embodiments herein provide a formulation base of bioactive compounds that will continue to remain active throughout the day after application by the user. In certain embodiments, the invention provides a method of sanitizing a surface and/or user, comprising providing a composition comprising one or more antimicrobial and/or antiviral components, and a water and oil formulation, wherein the water and oil formulation contains a predominance of water, and administering an effective amount to the surface and/or user. In some embodiments, a method of sanitizing a surface and/or user can include providing a composition comprising one or more antimicrobial and/or antiviral components, and a water and oil formulation, wherein the composition includes one or more of the following: benzalkonium chloride, zinc source (e.g., zinc salts and their hydrates such as zinc sulfate, zinc chloride, zinc gluconate, zinc oxide and its forms (e.g., nanoemulsions and nanoparticles)), tributyl phosphate, soybean oil, and/or Triton X-100, or an analog, derivative, salt, or pharmaceutical equivalent thereof. In further embodiments, the composition can be a cream. In further embodiments, the composition may be administered to the user's hand. In some embodiments, the composition may be administered to reduce, prevent and/or treat conditions associated with infection by viruses, including but not limited to, coronaviruses.

In some embodiments, the composition with a formulation base of bioactive compounds with antimicrobial and/or antiviral properties that will continue to remain active throughout the day, is applied topically. In accordance with various embodiments herein, the bioactive compounds in topical formulation comprises one or more of the following: benzalkonium chloride, zinc source (e.g., zinc salts and their hydrates such as zinc sulfate, zinc chloride, zinc gluconate, zinc oxide and its forms (e.g., nanoemulsions and nanoparticles), tributyl phosphate, soybean oil, and/or Triton X-100, or an analog, derivative, salt, or pharmaceutical equivalent thereof. In some embodiments, the active agent in the topical formulation is a combination of benzalkonium chloride, zinc oxide nanoemulsion, or an analog, derivative, salt, or pharmaceutical equivalent thereof. The concentration of the active agent in the topical formulation may range from about 0.1-30% (w/w). F or example, the active agent may comprise about. 01-5%, 0.5-3%, 1-2%, 1-3%, 2-10%, 5-10%, 5-15%, 10-15%, 15-20%, 10-20%, 20-25%, 15-30%, 20-30%, 10-30%, or 25-30% (w/w) of the topical formulation. In accordance with various embodiments herein, the concentration of the active agent in the topical formulation described herein refers to the percentage of the total weight of the active agent in dry form of the total weight of the topical formulation as a whole.

In some embodiments, the topical formulation further comprises one or more emollients, fragrances, or pigments. In some embodiments herein, the formulation further contains thickening agents, wetting agents, fillers, preservatives, cross-linking agents, surfactants, and/or stabilizers, for example.

In some embodiments, as also described herein, the topical formulation is or includes an ointment base. Or, for example, the ointment base can be a cream base. In certain embodiments, for example, the topical formulation includes a cream base where the cream base contains more than 40% water and volatiles and/or typically contain less than 50% hydrocarbons, waxes, or polyols as the vehicle for the drug substance. The cream base can be a multiphase preparation containing a lipophilic phase and an aqueous phase. In some instances, the cream base is a lipophilic cream base, which has a lipophilic phase as the continuous phase. Such a cream base can contain water-in-oil emulsifying agents such as wool alcohols, sorbitan esters and monoglycerides. In some instances, the cream base is a hydrophilic cream base, which has an aqueous phase as the continuous phase. In some embodiments, such a cream base contains oil-in-water emulsifying agents such as sodium or trolamine soaps, sulfated fatty alcohols, polysorbates and polyoxyl fatty acid and fatty alcohol esters, which can be in combination with water-in-oil emulsifying agents.

In some embodiments, the invention includes a topical, spray composition. For example, certain embodiments include a composition comprising benzalkonium chloride, zinc source (e.g., zinc salts and their hydrates such as zinc sulfate, zinc chloride, zinc gluconate, zinc oxide and its forms (e.g., nanoemulsions and nanoparticles)), tributyl phosphate, soybean oil, and/or Triton X-100, or an analog, derivative, salt, or pharmaceutical equivalent thereof, formulated to be applied to a subject as a topical, medicinal spray. The compositions can be dispensed from any dispenser, preferably a dispenser which provides the composition as a spray. In some embodiments, the composition is dispensed from a pump dispenser or from an aerosol dispenser.

In some embodiments, the composition can additionally comprise from about 10% to 90% of propellant in order to provide a suitable pressure within the aerosol dispenser. Generally, propellant is not required for compositions dispensed from a pump dispenser. However, if desired, in some embodiments, such compositions can also comprise from about 10% to 90% of a propellant which is liquid at room temperature In various embodiments, the present invention provides pharmaceutical compositions including a pharmaceutically acceptable excipient along with an effective amount of composition comprising one or more of the following: benzalkonium chloride, zinc source (e.g., zinc salts and their hydrates such as zinc sulfate, zinc chloride, zinc gluconate, zinc oxide and its forms (e.g., nanoemulsions and nanoparticles), tributyl phosphate, soybean oil, and/or Triton X-100, or an analog, derivative, salt, or pharmaceutical equivalent thereof. “Pharmaceutically acceptable excipient” means an excipient that is useful in preparing a pharmaceutical composition that is generally safe, non-toxic, and desirable, and includes excipients that are acceptable for veterinary use as well as for human pharmaceutical use. Such excipients may be solid, liquid, semisolid, or, in the case of an aerosol composition, gaseous.

In various embodiments, the pharmaceutical compositions can be formulated for delivery via any route of administration. “Route of administration” refers to any administration pathway known in the art, including but not limited to aerosol and topical.

Embodiments of the present disclosure are further described in the following examples. The examples are merely illustrative and do not in any way limit the scope of the invention as claimed.

### Example 1: A Persistent Hand Sanitizer

In accordance with various embodiments herein, a class of hand cream can contain several components at concentrations shown to possess antimicrobial activity through separate mechanisms of action. Also described herein, are additional compounds showing the ability at the described concentrations of having antiviral activity, including the ability to inactivate enveloped viruses. The described formulations of these compounds are water/oil formulations, containing a predominance of water, as to impart a non-greasy feel. This class of formulation is designed to be applied once a day (or more), provide antimicrobial and antiviral protection during this period, and thus exhibit persistence. This class of formulation is referred to as “persistent sanitizer.”

Currently, commercially available hand sanitizers provide a point of protection, where once one has come in contact with a contaminated surface/object or has come in contact with another person, they can be used to flash sanitizer the hands to kill microbes and inactivate viruses. This protection does not persist though. One must apply it each time one comes in contact with such sources. In contrast, in accordance with various embodiments herein, a formulation base of bioactive compounds will continue to remain active throughout the day after an initial application.

### Example 2: Bio-Actives and their Relative Concentrations in Formulation

1. Benzalkonium chloride (0.1-0.2%, preferably 0.18%)—Broad antimicrobial activity in this concentration. For example, reference Bondurant, et al. 2019, demonstrates the persistent antibacterial efficacy of a hand sanitizer containing benzalkonium chloride on human skin at 1, 2, and 4 hours after application. Also, for example, Romanowski, et al., 2019 (Benzalkonium Chloride Demonstrates Concentration-Dependent Antiviral Activity Against Adenovirus In Vitro.), demonstrates that it provides some antiviral activity including non-enveloped activity.

2. Zinc Oxide (0.05-4%, preferably 3%)—Antimicrobial activity in this concentration range, as well as antiviral activity. For example, references Siddiqi, et al. 2018 Properties of Zinc Oxide Nanoparticles and Their Activity Against Microbes, and Ghaffarit, et al. 2019—Inhibition of H1N1 influenza virus infection by zinc oxide nanoparticles another emerging application of nanomedicine. In some cases, zinc salts and their hydrates can be included.

3. Tributyl Phosphate (8 parts)—(0.08-0.8%).

4. Soybean Oil (64 parts)—(0.64-6.4%).

5. Triton X-100 (8 parts)—(0.08-0.8%).

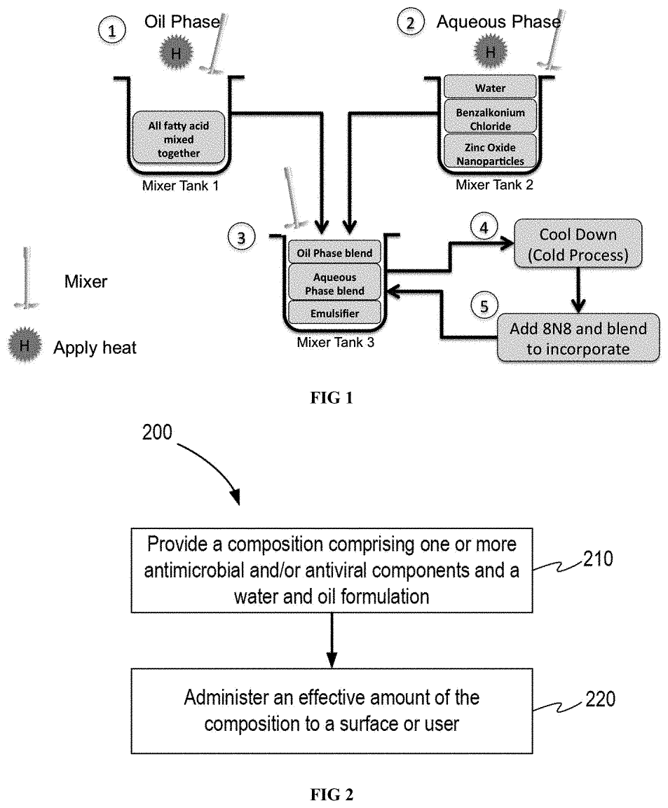

Referred to as 8N8, this mixture of surfactants has been shown to have potent anti-enveloped viral activity. For example, reference Hamouda, et al. 2001—A novel surfactant nanoemulsion with a unique non-irritant topical antimicrobial activity against bacteria, enveloped viruses and fungi. It can be used at 1-10% of the final cream formulation (see FIG. 1).

In some embodiments, the bioactive base of this formulation contributes less than 9% of the total formulation weight for weight. The remaining portion of the formulation consists of constituents commonly found in hand creams. Water provides greater than 50% of the formulation. In certain embodiments, the formulation has no ethyl or isopropyl alcohols.

FIG. 2 shows a method of sanitizing a surface or user, according to certain embodiments. At operation 210, method 200 can include providing a composition comprising one or more antimicrobial and/or antiviral components and a water and oil formulation. In some aspects, the water and oil formulation can contain a predominance of water (e.g., there is more water than oil, more than 50% of the formulation is water, or the like, as would be appreciated by one of ordinary skill in the art with the benefit of this disclosure).

At operation 220, method 200 can include administering an effective amount of the composition to the surface or user. In some cases, the composition can include one or more of the following: benzalkonium chloride, zinc oxide nanoparticles; tributyl phosphate; soybean oil; or Triton X-100 or an analog, derivative, salt, or pharmaceutical equivalent thereof. The composition can be configured to reduce, prevents and/or treat conditions associated with infection by viruses, including COVID-19. In some cases, the composition may be administered topically to the user (e.g., a hand cream).

The various methods and techniques described above provide a number of ways to carry out the invention. Of course, it is to be understood that not necessarily all objectives or advantages described may be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as may be taught or suggested herein. A variety of advantageous and disadvantageous alternatives are mentioned herein. It is to be understood that some preferred embodiments specifically include one, another, or several advantageous features, while others specifically exclude one, another, or several disadvantageous features, while still others specifically mitigate a present disadvantageous feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be mixed and matched by one of ordinary skill in this art to perform methods in accordance with principles described herein. Among the various elements, features, and steps, some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

Many variations and alternative elements have been disclosed in embodiments of the present invention. Still further variations and alternate elements will be apparent to one of skill in the art. Among these variations, without limitation, are the selection of constituent modules for the inventive compositions, and the diseases and other clinical conditions that may be diagnosed, prognosed or treated therewith. Various embodiments of the invention can specifically include or exclude any of these variations or elements.

In some embodiments, the numbers expressing quantities of ingredients, properties such as concentration, reaction conditions, and so forth, used to describe and claim certain embodiments of the invention are to be understood as being modified in some instances by the term “about.”

Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

In some embodiments, the terms “a,” “an,” and “the” and similar references used in the context of describing a particular embodiment of the invention (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments of this invention are described herein, including the best mode known to the inventors for carrying out the invention. Variations on those preferred embodiments will become apparent to those of ordinary skill in the art upon reading the foregoing description.

It is contemplated that skilled artisans can employ such variations as appropriate, and the invention can be practiced otherwise than specifically described herein. Accordingly, many embodiments of this invention include all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above cited references and printed publications are herein individually incorporated by reference in their entirety.

In closing, it is to be understood that the embodiments of the invention disclosed herein are illustrative of the principles of the present invention. Other modifications that can be employed can be within the scope of the invention. Thus, by way of example, but not of limitation, alternative configurations of the present invention can be utilized in accordance with the teachings herein. Accordingly, embodiments of the present invention are not limited to that precisely as shown and described.

What is claimed is:

1. A persistent sanitizer composition, comprising:
a formulation base of one or more bioactive compounds that remains active throughout an entire day after application,
wherein the formulation base comprises a composition of one or more of the following components:
benzalkonium chloride;
zinc oxide nanoparticles;
tributyl phosphate;
soybean oil non-allergenic fatty acid; and
Triton X-100, or an analog, derivative, salt, or pharmaceutical equivalent thereof, and
wherein the composition is a hand cream with antibacterial and/or antiviral properties.

2. A sanitizer composition, comprising:
one or more antimicrobial and/or antiviral components; and
a water and oil formulation,
wherein the water and oil formulation contains a predominance of water.

3. The sanitizer composition of claim 2, wherein the composition comprises benzalkonium chloride, zinc source, tributyl phosphate, soybean oil, and/or Triton X-100, or an analog, derivative, salt, or pharmaceutical equivalent thereof.

4. The sanitizer composition of claim 3, wherein the benzalkonium chloride comprises a concentration of 0.1-0.2%.

5. The sanitizer composition of claim 3, wherein the benzalkonium chloride comprises a concentration of 0.18%.

6. The sanitizer composition of claim 3, wherein the zinc source comprises a concentration of 0.01-0.1%.

7. The sanitizer composition of claim 3, wherein the zinc oxide nanoparticles comprises a concentration of 0.075%.

8. The sanitizer composition of claim 3, wherein the zinc salts and their hydrates comprise a concentration of 0.05-4%.

9. The sanitizer composition of claim 3, wherein the tributyl phosphate comprises a concentration range of 0.08-0.8%.

10. The sanitizer composition of claim 3, wherein the soybean oil or non-allergenic fatty acid comprises a concentration range of 0.64-6.4%.

11. The sanitizer composition of claim 3, wherein the Triton X-100 comprises a concentration range of 0.08-0.8%.

12. The sanitizer composition of claim 6, wherein a nanoemulsion of the zinc source is formed using:
tributyl phosphate or an analog;
soybean oil or an analog; and
Triton-X100.

13. The sanitizer composition of claim 12, wherein the nanoemulsion comprises 1-10% of the sanitizer composition.

14. The sanitizer composition of claim 2, wherein the composition is a cream or hand cream.

15. The sanitizer composition of claim 2, wherein the formulation has no ethyl and/or isopropyl alcohol.

16. The sanitizer composition of claim 2, wherein the predominance of water provides a non-greasy feel to the user.

17. The sanitizer composition of claim 5, wherein the sanitizer composition comprises a formulation base of bioactive compounds that will continue to remain active throughout the day after application by a user.

18. The sanitizer composition of claim 5, wherein the composition reduces, prevents and/or treats conditions associated with infection by viruses, including but not limited to, COVID-19.

19. A method of sanitizing a surface or user, the method comprising:
providing a composition comprising one or more antimicrobial and/or antiviral components and a water and oil formulation,
wherein the water and oil formulation contains a predominance of water; and
administering an effective amount of the composition to the surface or user,
wherein the composition includes one or more of the following:
benzalkonium chloride;
zinc oxide nanoparticles;
tributyl phosphate;
soybean oil; or
Triton X-100 or an analog, derivative, salt, or pharmaceutical equivalent thereof, wherein the composition reduces, prevents and/or treat conditions associated with infection by viruses, including COVID-19.

20. The method of claim 19, wherein the composition is administered topically to the user as a hand cream.
